(19) United States
(12) Patent Application Publication
(10) Pub. No.: US 2024/0376271 A1
(43) Pub. Date: Nov. 14, 2024

(54) RADIATION STABLE SILICONE ELASTOMERS AND METHODS FOR FORMING RADIATION STABLE SILICONE ELASTOMERS

(71) Applicant: BATTELLE SAVANNAH RIVER ALLIANCE, LLC, AIKEN, SC (US)

(72) Inventors: TYLER C. GUIN, AIKEN, SC (US); GEORGE K. LARSEN, AIKEN, SC (US); NATHANIEL Z. HARDIN, FARMINGTON, MI (US)

(21) Appl. No.: 18/655,828

(22) Filed: May 6, 2024

Related U.S. Application Data
(60) Provisional application No. 63/500,743, filed on May 8, 2023.

(51) Int. Cl. C08G 77/00; C08G 77/08; C08G 77/20

(52) U.S. Cl. CPC C08G 77/80; C08G 77/08; C08G 77/20; C08G 2115/00

(57) ABSTRACT

A silicone elastomer is disclosed. The silicon elastomer includes a phenyl content of at least about 60 mol. %, a phenyl to methyl ratio of greater than about 80 mol. %, and exhibits a Shore D hardness of between about 15 and about 70. Methods for forming the silicone elastomer are also provided.

### CROSS REFERENCE TO RELATED APPLICATION

The present application claims the filing benefit of U.S. Provisional Application Ser. No. 63/500,743, filed May 8, 2023, which is incorporated herein by reference for all purposes.

### STATEMENT REGARDING FEDERALLY SPONSORED RESEARCH OR DEVELOPMENT

This invention was made with government support under Contract No. 89303321CEM000080 awarded by the United States Department of Energy. The government has certain rights in the invention.

### BACKGROUND

Nuclear energy and radioactive materials pose many environmental problems. For example, there is public concern surrounding safety issues related to nuclear power plants, their design, and operation. Further, there are environmental concerns related to handling and storage of radioactive materials. For instance, operation of nuclear power plants can produce large amounts of highly radioactive substances that need to be isolated from the environment and stored for long periods of time. Thus, materials used in nuclear power plants or to store radioactive substances must exhibit radiation resistance, such that the materials are not degraded upon exposure to gamma radiation.

One material used in a variety of applications includes silicone. Silicones are widely used elastomers due to their properties such as good elasticity, chemical inertness, and non-toxicity. Silicones can be used for tubing, linings, gaskets, etc. and other components present in nuclear power plants. Common silicone elastomers include crosslinked silicon polymers that contain a high fraction (often 100%) of methyl groups. Exposure of these silicon polymers to radiation can degrade the material to the point of failure. Accordingly, there is a need for radiation stable silicone elastomers that do not readily degrade upon nuclear radiation exposure.

### SUMMARY

Aspects of the present disclosure are directed to a silicone elastomer. The silicone elastomer includes a phenyl content of at least about 60 mol. % and a phenyl to methyl ratio of greater than about 80 mol. %. The silicone elastomer has a Shore D hardness of between about 15 and 70.

Aspects of the present disclosure are directed to a method for forming a silicone elastomer. The method includes mixing a monomer mixture with a solvent and water, the monomer mixture comprising one or more dimethoxy silanes and one or more trimethoxy silanes to form a precursor composition comprising a plurality of polysiloxane oligomers; heating the precursor composition to remove water and the solvent; adding one or more catalyst to the precursor composition; and vacuum curing the precursor composition in steps to a final curing temperature of about 200° C. to form the silicone elastomer.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 depicts a flow diagram of an example method according to example embodiments of the present disclosure.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

As used herein, the term “polymer” generally includes, but is not limited to, homopolymers; copolymers, such as, for example, block, graft, random and alternating copolymers; and terpolymers; and blends and modifications thereof. Furthermore, unless otherwise specifically limited, the term “polymer” shall include all possible geometrical configurations of the material. These configurations include, but are not limited to isotactic, syndiotactic, and random symmetries.

As used herein, the term “substantially free” means no more than an insignificant trace amount present and encompasses completely free (e.g., 0 molar % up to 0.01 molar %).

All references to singular characteristics or limitations of the present invention shall include the corresponding plural characteristic or limitation, and vice versa, unless otherwise specified or clearly implied to the contrary by the context in which the reference is made.

The methods and compositions of the present invention, including components thereof, can comprise, consist of, or consist essentially of the essential elements and limitations of the invention described herein.

Silicones can be colorless oils or rubber-like substances (e.g., elastomers) and can be used in a variety of applications such as sealants, adhesives, lubricants, in medicine, or for thermal or electrical insulation. Certain uses of silicones, for instance, as components of nuclear power cables or medical instruments, can expose the silicone to nuclear radiation. As such, there is a need for radiation stable silicone elastomers that maintain desirable properties and are easily processable.

Silicones generally have the following formula:

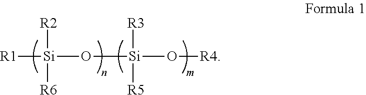

R₁-R₆ can include a variety of substituted or unsubstituted hydrocarbon groups. For instance, many silicones include methyl, phenyl, and vinyl R groups. Commonly used silicones include a high number of methyl substituents. For instance, certain silicones can include up to 100% of methyl substituents. However, upon radiation exposure these methyl groups readily degrade forming crosslinks, which can make the silicone brittle or can form byproducts, which can create voids in the material that make the silicone material susceptible to failure. Utilization of phenyl R groups in place of methyl R groups can increase the radiation stability of the silicone, however such substitutions reduce the elasticity of the silicone. Highly phenyl-substituted silicones are often crosslinked via vinyl chemistry, which is also readily attacked by radiation. Furthermore, silicone having high phenyl substituents (e.g., 100% phenyl R groups) are not elastomeric. Additionally, the terminal groups as shown by R₁ and R₄ are often alkyl groups that can also be crosslinked to other functional groups within the polymer that are susceptible to degradation upon exposure to nuclear radiation. The effects of crosslinking and degradation caused by the irradiation of silicone can change mechanical properties of the silicone, such as hardness, tensile strength, and elongation to break as well as the storage modulus and the glass transition temperature.

Embodiments of the present disclosure provide a silicone elastomer having a phenyl content of at least 60 mol. % and a phenyl to methyl ratio of greater than 80 mol. %. The silicone elastomer has a Shore D hardness of between about 15 and 70. The silicone elastomer maintains a high phenyl content with good radiation resistance, while still maintaining desirable elastomeric properties. Accordingly, the silicone elastomer provides suitable processability and elastomeric properties, while maintaining good radiation stability.

In embodiments, the silicone elastomer is as shown in generic Formula 1 above. As shown, the silicone elastomer includes a polysiloxane backbone having alternating silicon and oxygen bonds with R groups attached thereto. In embodiments, n is greater than 1 and less than 50 and m is greater than 1 and less than 50.

R₁-R₆ can include a variety of silicon atom-bonded, substituted or unsubstituted hydrocarbon groups including alkyl groups (e.g., methyl, ethyl, propyl, isopropyl, butyl, isobutyl, tert-butyl, pentyl, neopentyl, hexyl, cyclohexyl, octyl, nonyl and decyl); aryl groups (e.g., phenyl, tolyl, xylyl and naphthyl); aralkyl groups (e.g., benzyl, phenylethyl, and phenylpropyl); alkenyl groups (e.g., vinyl, allyl, propenyl, isopropenyl, butenyl, hexenyl, cyclohexenyl and octenyl); and derivatives of the foregoing groups. Certain derivatives can include those in which some or all of the hydrogen atoms are substituted with halogen atoms (e.g., chloromethyl, chloropropyl, bromoethyl, and trifluoropropyl); cyano groups (e.g., cyanoethyl); hydroxyl groups, ester groups, etc. In certain embodiments, R₁-R₆ can include hydrogen. In certain embodiments, none of R₁-R₆ include alkenyl groups, such as vinyl. Specifically, in embodiments neither terminal groups, R₁ nor R_{4,} include alkenyl groups (e.g., vinyl). More specifically, in certain embodiments both terminal groups, R₁ and R_{4,} are aryl groups (e.g., phenyl).

A specific embodiment of the silicone elastomer of Formula 1 is where n is greater than 1 and less than 50; where m is greater than 1 and less than 50; where R₁ is an aryl group, such as phenyl; R₂ is an aryl group, such as phenyl; R₃ is an aryl group, such as phenyl; R₄ is an aryl group, such as phenyl; R₅ is an aryl group, such as phenyl; and R₆ is an alkyl group, such as methyl. Indeed, in such embodiments, the silicon elastomer can include only methyl phenyl monomeric blocks and diphenyl monomeric blocks with aryl group terminations (e.g., phenyl).

An example silicone elastomer is shown in Formula 2 below, where n is greater than 1 and less than 50 and m is greater than 1 and less than 50.

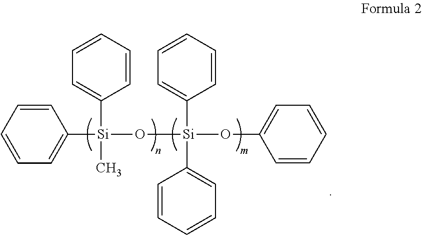

Notably, in embodiments the silicone elastomer is substantially free from alkenyl groups (e.g., vinyl).

The aryl to alkyl ratio of the R groups can vary, with at least 50% of the R groups present on the oligomer being an aryl R group. In embodiments, at least 60%, such as at least 70%, such as at least 80%, such as at least 90% of the R groups present on the oligomer include an aryl R group. In embodiments, less than 50% of the R groups present on the siloxane oligomer include an alkyl R group, such as less than 40%, such as less than 20%, such as less than 10%.

The silicone elastomer can have a phenyl content of at least about 60 mol. %, such as at least about 65 mol. %, such as at least about 70 mol. %, such as at least about 75 mol. %, such as at least about 80 mol. %, such as at least about 85 mol %, such as at least about 90 mol. %. In other embodiments, the silicone elastomer has a phenyl to methyl ratio of greater than 80 mol. %. The silicone elastomer composition can have a phenyl content of at least 80 wt. %, such at least 85 wt. % such as at least 90 wt. %.

Notably, in embodiments none of the R groups include an alkenyl group, such as vinyl. Thus, the silicone elastomer can be substantially free of vinyl groups. For instance, the silicone elastomer can include less than 5 mol. % of vinyl groups, such as less than 4 mol. % vinyl groups, such as less than 3 mol. % vinyl groups, such as less than 2 mol. % vinyl groups, such as less than 1 mol. % vinyl groups. In embodiments, none of the R groups comprise an alkenyl group, such as vinyl.

The silicone elastomer can include a plurality of crosslinks. In embodiments, none of the crosslinks comprise a vinyl group crosslink. A vinyl group crosslink as used herein refers to a crosslink formed by a reaction of a vinyl group (i.e., a C═C bond) and including a carbon-carbon bond, including a carbon-to-carbon single bond, formed upon the vinyl group reaction. In embodiments, less than 5 mol. % of the crosslinks are vinyl group crosslinks, such as less than about 4 mol. %, such as less than about 3 mol. %, such as less than about 2 mol. %, such as less than about 1 mol. %. As such, the resulting silicone elastomer is substantially free from any vinyl group crosslinks.

Notably, the silicone elastomer has improved stability when exposed to nuclear radiation while still maintaining desired elastomeric properties. For instance, upon exposure to a radiation dose of about 1000 kGy the composition exhibits a change in crosslink density of less than 10%. The silicone elastomer can have a and a Shore D hardness of between about 15 and about 70, such as between about 20 and about 65, such as between about 25 and 60, such as between about 30 and 55, such as between about 35 and 50, such as between about 40 and 45. Shore hardness can be measured with a durometer with the hardness being determined by the penetration of the durometer indenter foot into the sample being tested.

The silicone elastomer of the present disclosure can also exhibit a desired elasticity. Elasticity, as used herein, means the property of a body or material to change shape when a force is applied thereon and to return to its original shape when the applied force is removed (example: spring). The modulus of elasticity, as used herein, is defined, for example, as the slope of the graph in the stress-stretching diagram at uniaxial load with infinitesimal change in distortion at zero stress. Most materials have a(n) (at least small) linear range, this is also called Hooke's range. The following applies:

$$E = σ / ε = const$$

Here, σ(=force/surface) denotes the mechanical stress (normal stress, not shear stress) and ε=ΔL/L.sub.0 denotes the stretching. The stretching is the ratio of the change in length ΔL=L−L.sub.0 to the original length L.sub.0. The unit of the modulus of elasticity is that of a stress.

The modulus of elasticity is called material constant, since by using it and the transverse Poisson's numbers the law of elasticity is established. However, the modulus of elasticity is not constant with respect to all physical quantities. It depends on various environmental conditions such as, for example, temperature or humidity. Therefore, comparable conditions are assumed herein when determining the modulus of elasticity.

The silicone elastomer of the present disclosure can have a modulus of elasticity of about 517 MPa to about 590 MPa and/or a compressive modulus of about 200 MPa to about 500 MPa.

The silicone elastomer can be further combined with other additives to increase radiation resistance or to alter properties of the silicone elastomer composition. For instance, phenyl silicone oils can be added to the silicone elastomer composition to reduce the glass transition temperature of the composition and thus improve the elasticity of the material. Suitable phenyl silicone oils can include Conquest West CQ-705 silicone oil. Other additives, such as naphthalene additives can be incorporated with the silicone elastomer composition to further enhance the gamma radiation stability of the composition.

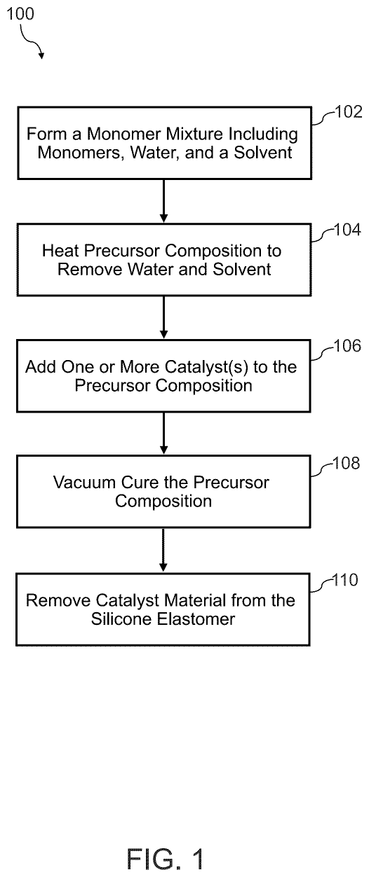

FIG. 1 depicts a flow diagram of one example method (100) according to example aspects of the present disclosure. Those of ordinary skill in the art, using the disclosures provided herein, will understand that various steps of any of the methods described herein can be omitted, expanded, performed simultaneously, rearranged, and/or modified in various ways without deviating from the scope of the present disclosure. In addition, various steps (not illustrated) can be performed without deviating from the scope of the present disclosure. All combinations of method or process steps as used herein can be performed in any order, unless otherwise specified or clearly implied to the contrary by the context in which the referenced combination is made.

At (102), the method can include forming a monomer mixture that includes monomers mixed with water and a suitable solvent. Example monomers that can be used include methoxy-substituted silanes, such as dimethoxy silanes (shown in Formula 3) and trimethoxy silanes (shown in Formula 4).

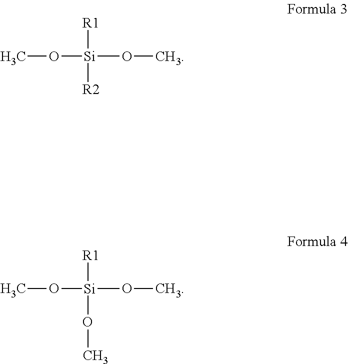

In Formula 3 or 4, R₁ and/or R₂ groups can include alkyl groups (e.g., methyl, ethyl, propyl, isopropyl, butyl, isobutyl, tert-butyl, pentyl, neopentyl, hexyl, cyclohexyl, octyl, nonyl and decyl); aryl groups (e.g., phenyl, tolyl, xylyl and naphthyl); aralkyl groups (e.g., benzyl, phenylethyl, and phenylpropyl); alkenyl groups (e.g., vinyl, allyl, propenyl, isopropenyl, butenyl, hexenyl, cyclohexenyl and octenyl); and derivatives of the foregoing groups. Certain derivatives can include those in which some or all of the hydrogen atoms are substituted with halogen atoms (e.g., chloromethyl, chloropropyl, bromoethyl, and trifluoropropyl); cyano groups (e.g., cyanoethyl); hydroxyl groups, ester groups, etc. In certain embodiments, none of R₁ or R₂ include alkenyl groups, such as vinyl.

In a certain embodiment, the dimethoxy silane can include diphenyl dimethoxy silane, phenyl methyl dimethoxysilane and combinations thereof. In embodiments, the trimethoxy silane can include phenyl trimethoxy silane.

The selected monomers can be mixed with water and one or more solvents, such as a polar organic solvent. Suitable polar organic solvents include methanol, acetone, acetonitrile, dimethylformamide, propanol, dioxane, cyclohexane, N-methyl-2-pyrrolidone, ethanol, dimethyl sulfoxide, methylene chloride, diethyl ether, acetic acid, 1-butanol, butanone, dimethylacetamide, ethyl acetate, hexane, chloroform, tetrahydrofuran, pentane, isopropanol, 1,2-dichloroethane, methyl acetate, and combinations thereof.

Mixing of the selected substituted methoxy silane monomers with the water in the solvent drives the substituted methoxy silanes to form silanol precursors, which then rapidly form polysiloxane oligomers. Accordingly, in the composition the substituted methoxy silanes form substituted organosilanes as the methoxy groups are converted to hydroxyl group. Example formulas of silanol precursors are shown in Formulas 5 and 6 below.

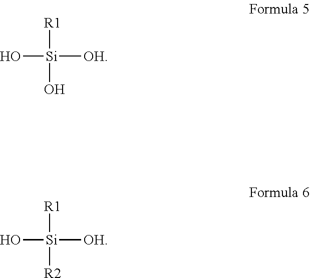

In Formula 5 or 6, R₁ and/or R₂ groups can include alkyl groups (e.g., methyl, ethyl, propyl, isopropyl, butyl, isobutyl, tert-butyl, pentyl, neopentyl, hexyl, cyclohexyl, octyl, nonyl and decyl); aryl groups (e.g., phenyl, tolyl, xylyl and naphthyl); aralkyl groups (e.g., benzyl, phenylethyl, and phenylpropyl); alkenyl groups (e.g., vinyl, allyl, propenyl, isopropenyl, butenyl, hexenyl, cyclohexenyl and octenyl); and derivatives of the foregoing groups. Certain derivatives can include those in which some or all of the hydrogen atoms are substituted with halogen atoms (e.g., chloromethyl, chloropropyl, bromoethyl, and trifluoropropyl); cyano groups (e.g., cyanoethyl); hydroxyl groups, ester groups, etc. In certain embodiments, none of R₁ or R₂ include alkenyl groups, such as vinyl.

As noted, mixing of the monomers, water, and solvent forms a precursor composition containing a plurality of short chain polysiloxane oligomers. For instance, during mixing the disilanols and trisilanols can rapidly form polysiloxane oligomers. For instance, in embodiments, the polysiloxane oligomers are formed solely from di-phenyl, mono-phenyl, and/or mono-methyl versions of reactive organosilanes. The polysiloxane oligomers can include cyclic polysiloxane oligomers, such as short chain polysiloxane oligomers.

At (104), the mixture is heated to remove water and solvent from the mixture. For instance, the mixture can be heated to a temperature above 100° C. to remove any remaining water or solvent from the mixture. Heating of the mixture can further increase reaction between the silanols, which can increase the amount of polysiloxane oligomers present in the precursor composition.

At (106), one or more catalysts can be added to the precursor composition. For instance, in embodiments the catalyst can include a suitable metal catalyst. Suitable metal catalysts can include transition metal catalysts or post-transition metal catalysts. In certain embodiments, the catalyst can include a tin-catalyst.

At (108), once the catalyst(s) is combined with the precursor composition, the method includes vacuum curing the composition. For instance, the precursor composition can be placed in suitable vessels and placed in a vacuum oven for curing. The vacuum curing can take place in a series of steps, with the temperature increasing over a period of time until a final curing temperature of 200° C. is achieved. The curing can take place over a temperature range of from about 50° C. to about 200° C. For instance, the starting curing temperature can be about 50° C. and the temperature can be increased in a stepwise manner until the final curing temperature of about 200° C. is achieved. The vacuum curing can take place in a vacuum environment, such as one that is below atmospheric pressure. As discovered by the present inventors, if the curing temperature is increased too quickly, the resultant silicone elastomer is filled with bubbles and is not usable. However, if the curing is done too slowly, residual silanols can remain, which are susceptible to radiation damage. After curing as disclosed, the silicone elastomer is achieved.

During curing, the trisilanol monomers can crosslink the silicone elastomer such that no additional cross linking agents are needed. As such, advantageously, no additional crosslinking agents are required, saving both production costs and production time.

At (110), optionally, the catalyst(s) can be removed from the composition containing the silicone elastomer. Removal of the catalysts after curing can be necessary since any remaining residual catalyst can catalyze damage from any subsequent radiation exposure of the silicone elastomer.

While certain embodiments of the disclosed subject matter have been described using specific terms, such description is for illustrative purposes only, and it is to be understood that changes and variations may be made without departing from the spirit or scope of the subject matter.

What is claimed is:

1. A silicone elastomer, comprising:
a phenyl content of at least about 60 mol. %;
a phenyl to methyl ratio of greater than about 80 mol. %; and
a Shore D hardness of between about 15 and about 70.

2. The silicone elastomer of claim 1, comprising phenyl terminal R groups.

3. The silicone elastomer of claim 1, wherein the silicone elastomer is free of vinyl terminal R groups.

4. The silicone elastomer of claim 1, comprising a plurality of crosslinks, wherein the crosslinks comprise less than 5 mol. % of vinyl groups or a reaction product thereof.

5. The silicon elastomer of claim 4, wherein the crosslinks comprise less than 1 mol. % of vinyl groups or a reaction product thereof.

6. The silicone elastomer of claim 1, wherein about 90% or more of monomeric units of the silicone elastomer are methyl phenyl monomeric units, diphenyl monomeric units, or a combination thereof

7. The silicone elastomer of claim 6, wherein the monomeric units of the silicone elastomer consist of methyl phenyl monomeric units, diphenyl monomeric units, or a combination thereof.

8. The silicone elastomer of claim 1, wherein upon exposure to a radiation dose of about 1000 kGy, the silicone elastomer exhibits a change in crosslink density of less than about 10%.

9. A method for forming a silicone elastomer composition, the method comprising:
mixing a monomer mixture with a solvent and water, the monomer mixture comprising one or more dimethoxy silanes and one or more trimethoxy silanes to form a precursor composition comprising a plurality of polysiloxane oligomers;
heating the precursor composition to remove water and the solvent;
adding one or more catalyst to the precursor composition; and
vacuum curing the precursor composition in steps to a final curing temperature of about 200° C. to form the silicone elastomer.

10. The method of claim 9, wherein the one or more dimethoxy silanes comprise diphenyl dimethoxysilane, phenyl methyl dimethoxysilane, and combinations thereof.

11. The method of claim 9, wherein the trimethoxy silanes comprise phenyl trimethoxysilane.

12. The method of claim 9, wherein the solvent comprises a polar organic solvent.

13. The method of claim 12, wherein the polar organic solvent comprises acetonitrile.

14. The method of claim 9, wherein the one or more catalyst comprise a tin-catalyst.

15. The method of claim 9, wherein vacuum curing the composition in steps to a final curing temperature of about 200° C. comprises vacuum curing at a starting temperature of 50° C. and increasing the temperature in a stepwise manner until the final curing temperature is achieved.

16. The method of claim 9, wherein the precursor mixture comprises a plurality of short chain polysiloxane oligomers.

17. The method of claim 16, wherein the plurality of short chain polysiloxane oligomers comprise cyclic polysiloxane oligomers.

18. The method of claim 9, wherein the one or more trimethoxy silanes crosslink the silicone elastomer during the step of vacuum curing, and wherein the precursor composition comprises no additional crosslinking agents.

19. The method of claim 9, wherein the method is free of vinyl crosslinking agents.

20. The method of claim 9, comprising, after vacuum curing, removing the one or more catalysts.
